(19) United States
(12) Patent Application Publication
(10) Pub. No.: US 2016/0164625 A1
(43) Pub. Date: Jun. 9, 2016

(54) DISTRIBUTED WAVE DIVISION MULTIPLEXING SYSTEMS

(71) Applicant: CommScope Technologies LLC, Hickory, NC (US)

(72) Inventors: Erik J. GRONVALL, Bloomington, MN (US); Timothy G. BADAR, St. Paul, MN (US)

(73) Assignee: CommScope Technologies LLC, Hickory, NC (US)

(21) Appl. No.: 14/905,634

(22) PCT Filed: Jul. 16, 2014
(86) PCT No.: PCT/US2014/046846

§ 371 Date: Jan. 15, 2016

Related U.S. Application Data
(60) Provisional application No. 61/846,853, filed on Jul. 16, 2013.

(51) Int. Cl. H04J 14/02

(52) U.S. Cl. CPC H04J 14/0257; H04J 14/0282

(57) ABSTRACT

A distributed wave division multiplexing system includes a first multiplexing device and multiple second multiplexing devices. The first multiplexing device separates Y number of subscriber signals carried over an input line onto X number of channel lines by wavelength. Each of the second multiplexing devices is coupled to the first multiplexing device by one of the channel lines. Each second multiplexing device separates X number of subscriber signals carried over the respective channel line onto Y number of output lines by wavelength. Each of the Y number of wavelengths subscriber signals carried over a first of the channel fibers is associated with a different one of the output fibers of the respective second multiplexing device. Each of the X number of subscriber signals carried over a first of the output fibers of each second multiplexing device is associated with a different one of the channel fibers.

### CROSS-REFERENCE TO RELATED APPLICATION(S)

This application is being filed on 16 Jul. 2014, as a PCT International Patent application and claims priority to U.S. Patent Application Ser. No. 61/846,853 filed on 16 Jul. 2013, the disclosure of which is incorporated herein by reference in its entirety.

### BACKGROUND

In fiber optic telecommunications systems, optical signal can be encoded using intensity (i.e., power) modulation. Accordingly, it is common for optical fibers to carry multiple subscriber signals that each have a different wavelength. Each subscriber signal is encoded by varying the intensity at its particular wavelength. An optical power splitter can split all of the subscriber signals from one optical fiber onto multiple splitter fibers. Each splitter fiber carries all of the subscriber signals, but has only a fraction of the power (i.e., intensity) of the unsplit subscriber signals.

In contrast, a wave division multiplexer (WDM) can separate the subscriber signals onto one or more channel fibers based on wavelength. Each of the separated subscriber signals has all of the power of the unseparated signals. However, each of the channel fibers carries fewer than all of the subscriber signals. The WDM also can join together multiple signals having different wavelengths into one carrier signal.

WDMs enables multiple subscriber signals to be carried over a single optical fiber by using different wavelengths of light (e.g., laser light, LED light, etc.) to carry different subscriber signals. In addition this technology makes it possible to perform bidirectional communications over one strand of optical fiber. Accordingly, WDM systems allow expansion of the capacity of a network without laying more fiber.

WDM systems are classified as one of three types based on different wavelength patterns: a conventional WDM; a dense WDM (DWDM); and a coarse WDM (CWDM). WDMs, DWDMs and CWDMs are based on the same concept of using multiple wavelengths of light on a single fiber, but differ in the spacing of the wavelengths, number of channels, and the ability to amplify the multiplexed signals in the optical space.

### SUMMARY

Aspects of the disclosure are directed to a distributed wavelength division multiplexer architecture including a first wavelength division multiplexer; and second wavelength division multiplexers. The first wavelength division multiplexer includes a first input and a plurality of first outputs. The first wavelength division multiplexer has a first filter criteria that assigns a respective set of subscriber wavelengths to each first output. Each set of subscriber wavelengths is different from each other set of subscriber wavelengths. The second wavelength division multiplexers have second inputs coupled to the first outputs of the first wavelength division multiplexer. The second wavelength division multiplexers each include a plurality of second outputs and a second filter criteria that assigns a subscriber wavelength from each different set of subscriber wavelengths to each of the second outputs.

In certain implementations, each of the second wavelength division multiplexers can be coupled to any of the first outputs of the first wavelength division multiplexer. The second wavelength division multiplexers are each compatible with any of the first outputs. In certain examples, the second wavelength division multiplexers are interchangeable with each other. In certain examples, the second wavelength division multiplexers do not need to be installed in any particular order, sequence, or configuration.

In certain implementations, the different sets of subscriber wavelengths corresponding to the first wavelength division multiplexer are not assigned duplicate subscriber wavelengths. In certain implementations, the second outputs corresponding to the second wavelength division multiplexers are not assigned duplicate subscriber wavelengths.

In certain implementations, a number of subscriber wavelengths in each set of subscriber wavelengths is equal to a number of second outputs of each second wavelength division multiplexer. In certain implementations, a number of subscriber wavelengths assigned to each second output is equal to a number of first outputs of the first wavelength division multiplexer.

In an example, the first outputs include eight first outputs and each set of subscriber wavelengths includes four subscriber wavelengths. In another example, the first outputs include four first outputs and each set of subscriber wavelengths includes eight subscriber wavelengths.

In certain examples, each set of subscriber wavelengths includes consecutive wavelengths. In certain examples, each set of subscriber wavelengths includes non-consecutive wavelengths.

Other aspects of the disclosure are directed to distributed wave division multiplexing systems including a first wave division multiplexer (WDM) and multiple identical second WDMs coupled to the first wave division multiplexer. In some implementations, the first and second WDMs separate the signals based on specific (i.e., discrete) wavelengths. In other implementations, the first and second WDMs separate the signals based on specific wavelength bands (i.e., wavelength ranges).

In some implementations, the first WDM is configured to receive an input fiber and to separate subscriber signals carried by the input fiber onto multiple channel fibers. The first WDM has a first set of filter criteria that assigns a corresponding plurality of wavelengths to each of the channel fibers so that the wavelength of each subscriber signal is assigned to one of the channel fibers. The first WDM separates the subscriber signals so that each channel fiber will receive any sub-signal having one of the corresponding wavelengths. Each second WDM receives one of the channel fibers of the first WDM. Each second WDM is configured to separate the subscriber signals carried by the received channel fiber onto multiple output fibers. Each second WDM has a second set of filter criteria that assigns a corresponding plurality of wavelengths to each of the output fibers so that the wavelength of each subscriber signal carried by the received channel fiber is assigned to one of the output fibers. Each second WDM separates the subscriber signals carried by the received channel fiber so that each output fiber will receive any subscriber signal having one of the corresponding wavelengths of that output fiber. For each of the channel fibers, each of the output fibers is assigned to a wavelength that matches one of the wavelengths assigned to the channel fiber.

In an example, the first WDM separates the subscriber signals onto four channel fibers and the second WDM separates the subscriber signals onto eight output fibers. In another example, the first WDM separates the subscriber signals onto eight channel fibers and wherein the second WDM separates the subscriber signals onto four output fibers.

In an example, the corresponding plurality of wavelengths assigned by the first set of filter criteria includes consecutive wavelengths. In another example, the corresponding plurality of wavelengths assigned by the first set of filter criteria includes non-consecutive wavelengths.

In an example, the first WDM is a CWDM. In another example, the first WDM is a DWDM. In another example, the second WDM is a CWDM. In another example, the second WDM is a DWDM.

Other aspects of the disclosure are directed to a method of configuring a distributed wave division multiplexing system. The method includes determining a number of unique wavelengths over which optical subscriber signals are transmitted; configuring a first wave division multiplexer to associate a respective set of wavelengths with each of “X” number of channel fibers; and configuring a second wave division multiplexer to associate each of “Y” number of output fibers with a respective set of wavelengths. Each set associated with the channel fibers includes “Y” number of wavelengths. Each set associated with the output fibers includes “X” number of wavelengths. Each of the “Y” number of wavelengths of the set associated with a first of the channel fibers is associated with a different one of the output fibers. Each of the “X” number of wavelengths of the set associated with a first of the output fibers is associated with a different one of the channel fibers. The values of “X” and “Y” are set so that X*Y is equal to the determined number of unique wavelengths.

In certain implementations, the method includes coupling the second wave division multiplexer to the first wave division multiplexer so that the second wave division multiplexer receives one of the first fibers as input.

In certain implementations, the method includes configuring additional wave division multiplexers identically to the second wave division multiplexer. In certain implementations, the method also includes coupling the additional wave division multiplexers to the first wave division multiplexer so that each channel fiber is input into one of the additional wave division multiplexers.

In an example, the value of “X” is four. In another example, the value of “X” is eight. In another example, the value of “Y” is four. In another example, the value of “Y” is eight.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of a first example distributed wave division multiplexing system configured in accordance with the principles of the present disclosure;

FIG. 2 is a schematic diagram of a second example distributed wave division multiplexing system configured in accordance with the principles of the present disclosure;

FIGS. 3A-3D provides one example of how an optical carrier signal can be divided into four carrier signals each including eight subscriber signals;

FIGS. 4A-4D provides another example of how an optical carrier signal can be divided into four carrier signals each including eight subscriber signals;

FIGS. 5A-5H provides one example of how an optical carrier signal can be divided into eight carrier signals each including four subscriber signals;

FIGS. 6A-6H provides another example of how an optical carrier signal can be divided into eight carrier signals each including four subscriber signals;

FIG. 7 illustrates the second multiplexing system where alternately assigned wavelengths sets are assigned to the channel fibers and consecutive assigned wavelengths sets are assigned to the output fibers;

FIGS. 8 and 9 are schematic diagrams of the distributed wave division multiplexing system of FIG. 2 showing example implementations of the first multiplexing device;

FIG. 10 illustrates one example combining device suitable for use as one of the combining devices of FIG. 9; and

FIG. 11 illustrates one example multiplexing device suitable for use as one of the second multiplexing devices of FIG. 1 2, 8, or 9.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A distributed wave division multiplexing system is configured to transmit multiple subscriber signals over one or more optical fibers. Each of the subscriber signals has a different wavelength or wavelength band than the other subscriber signals. For convenience, the remainder of this disclosure will refer only to wavelength. However, it will be understood that “wavelength” can refer to a band of wavelengths. The multiplexing system is configured to distribute the subscriber signals to service subscribers using a small number of components. Accordingly, “subscriber wavelengths” include wavelengths intended to be assigned to a subscriber or otherwise used in the network to carry communications signals. Reducing the number of components in an optical system aids in reducing the cost of installing and operating the optical system.

The terms “input” and “output” are used herein for convenience and should not be construed as limiting. Those skilled in the art understand that optical networks function in both directions (i.e., optical signals are sent to subscribers and from subscribers). For convenience, the optical networks disclosed herein are described as if the optical signals are passing to the subscribers. It will be understood, however, that optical signals can both enter and exit a device at an input and can both enter and exit a device at an output depending on the direction the signals are propagating through the network.

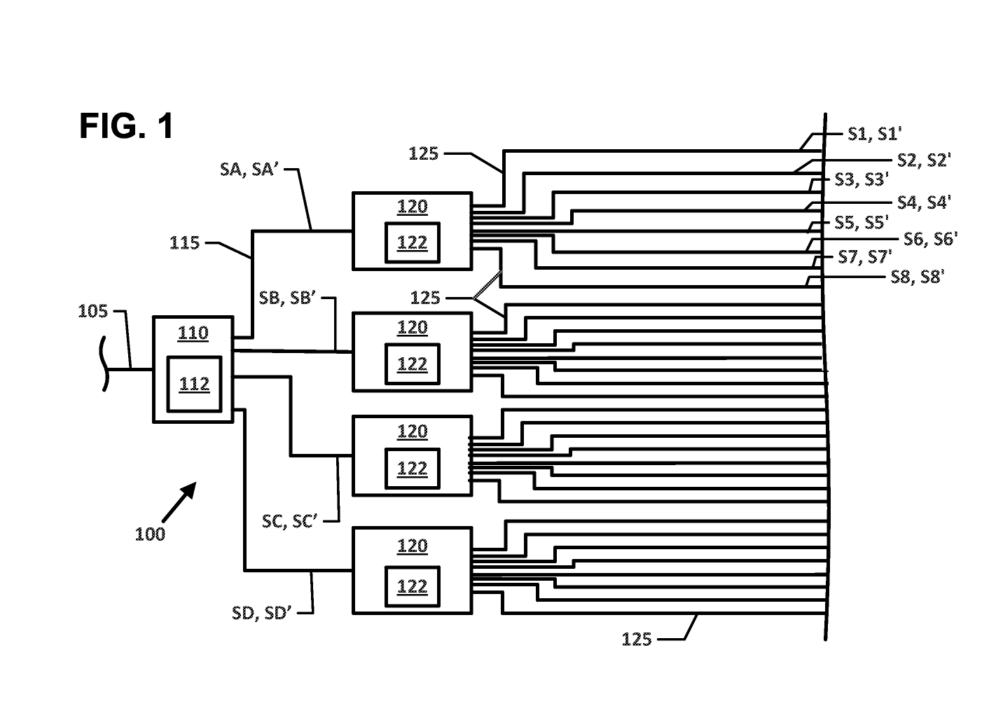

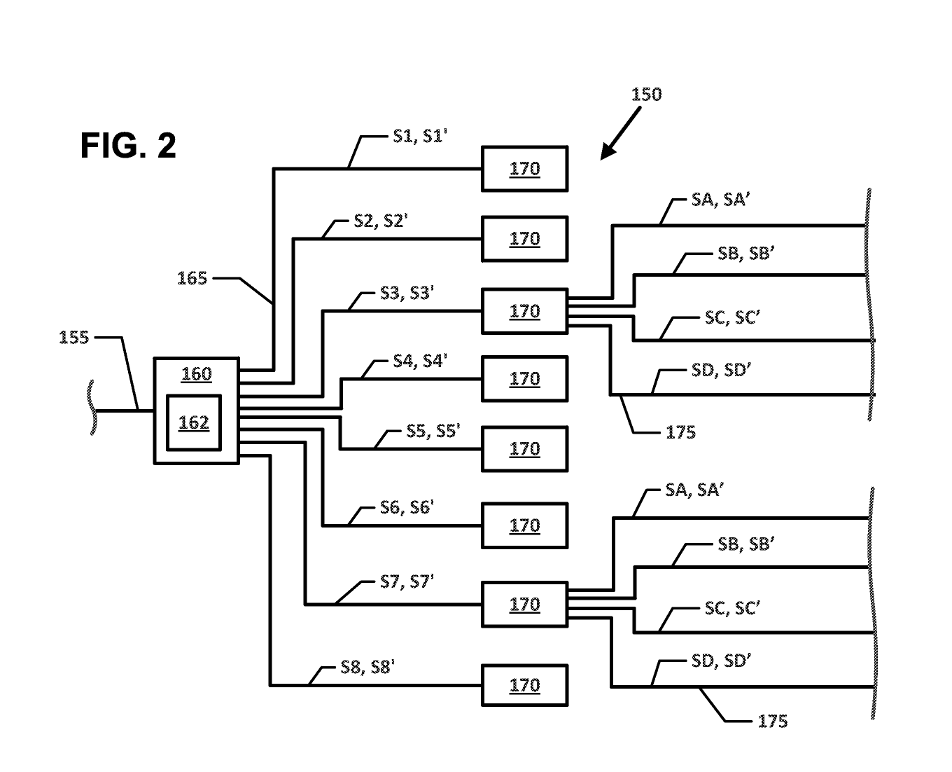

FIGS. 1 and 2 show schematic diagrams of distributed wave division multiplexing systems 100, 150 including a first multiplexing device 110, 160 and multiple second multiplexing devices 120, 170. The first multiplexing device 110, 160 includes a first WDM. Each of the second multiplexing devices 120, 170 includes a second WDM. The first multiplexing device 110, 160 has an input fiber 105, 155 (e.g., an optical fiber) and multiple channel fibers 115, 165. The first multiplexing device 110, 160 is configured based on first filter criteria 112, 162 that specify which subscriber signals are separated onto which channel fibers 115, 165. For example, the first filter criteria 112, 162 indicate a unique set of one or more wavelengths that are assigned to each channel fiber 115, 165. Each channel fiber 115, 165 receives any subscriber signal having one of the assigned wavelengths. The subscriber signals carried over the channel fibers 115, 165 have the same power as they did when carried over the input fiber 105, 155.

Each of the channel fibers 115, 165 functions as an input line for one of the second multiplexing devices 120, 170. Each second multiplexing device 120, 170 further separates the subscriber signals carried by the respective channel fiber 115, 165 onto multiple output fibers 125, 175. Each second multiplexing device 120, 170 is configured based on second filter criteria 122 that specify which subscriber signals are separated onto which output fibers 125, 175. (The second set of filter criteria is omitted from FIG. 2 for lack of space. However, it is understood that the second multiplexing devices 170 include filter criteria). For example, the second filter criteria 122 indicate a unique set of one or more wavelengths that are assigned to each output fiber 125, 175. Each output fiber 125, 175 receives any subscriber signal having one of the assigned wavelengths. The subscriber signals carried over the output fibers 125, 175 have the same power as they did when carried over the input line 105, 155.

In an example, each output fiber 215, 175 carries optical fibers having a single wavelength or band that is associated with a subscriber. In another example, each output fiber 125, 175 can carry optical fibers having either of two different wavelengths—one for transmit and one for receive. In yet another example, each output fiber 125, 175 can carry optical fibers having either of a particular wavelength that is associated with a particular subscriber or a wavelength associated with the central office. Each of the output fibers 125, 175 can carry optical fibers having the central office wavelength.

In certain implementations, each of the second multiplexing devices 120, 170 can be coupled to any of the first outputs of the first multiplexing device 110, 160. In certain examples, the second multiplexing devices 120, 170 are interchangeable with each other. Any of the second multiplexing devices 120, 170 can be switched with any other of the second multiplexing devices 120, 170. In certain examples, the second multiplexing devices 120, 170 do not need to be installed in any particular order, sequence, or configuration. For example, any of the second multiplexing devices 120, 170 can be coupled to any of the channel fibers 115, 165 and function.

In some implementations, the first filter criteria 112, 162 of the first multiplexing device 110, 160 require that the capacities of the sets of wavelengths assigned to the channel fibers 115, 165 (i.e., the number of wavelengths per channel fiber) is equal to the number of output lines 125, 175 of the second multiplexing devices 120, 170. The second filter criteria 122 of the second multiplexing devices 120, 170 requires that the capacities of the sets of wavelengths assigned to each of the output fibers 125, 175 (i.e., the number of wavelengths per output fiber) is equal to the number of channel fibers 115, 165 of the first multiplexing device 110, 160.

In some implementations, the first multiplexing device 110, 160 is a conventional WDM. In other implementations, the first multiplexing device 110, 160 is a DWDM. In still other implementations, the first multiplexing device 110, 160 is a CWDM. In some implementations, the second multiplexing devices 120, 170 are conventional WDMs. In other implementations, the second multiplexing devices 120, 170 are bi-directional WDMs. In still other implementations, the second multiplexing devices 120, 170 are DWDMs. In still other implementations, the second multiplexing devices 120, 170 are CWDMs.

In the example system 100 shown in FIG. 1, the first multiplexing device 110 separates the subscriber signals onto four channel fibers 115 and the second multiplexing devices 120 separate the subscriber signals onto eight output fibers 125. The first multiplexing device 110 assigns a set of eight wavelengths to each channel fiber 115; and each second multiplexing devices 120 assigns a set of four wavelengths to each output fiber 125. Accordingly, the system 100 can accommodate up to thirty-two subscriber signals being carried over the input fiber 105.

In the example shown, the first multiplexing device 110 assigns a first set SA, SA′ of wavelengths to a first channel fiber 115, a second set SB, SB′ of wavelengths to a second channel fiber 115, a third set SC, SC′ of wavelengths to a third channel fiber 115, and a fourth set SD, SD′ of wavelengths to a fourth channel fiber 115. Each of the second multiplexing devices 120 assigns a first set S1, S1′ of wavelengths to a first output fiber 125, a second set S2, S2′ of wavelengths to a second output fiber 125, a third set S3, S3′ of wavelengths to a third output fiber 125, a fourth set S4, S4′ of wavelengths to a fourth output fiber 125, a fifth set S5, S5′ of wavelengths to a fifth output fiber 125, a sixth set S6, S6′ of wavelengths to a sixth output fiber 125, a seventh set S7, S7′ of wavelengths to a seventh output fiber 125, and an eighth set S8, S8′ of wavelengths to an eighth output fiber 125.

In the example system 150 shown in FIG. 2, the first multiplexing device 160 separates the subscriber signals onto eight channel fibers 165 and the second multiplexing devices 170 separate the subscriber signals onto four output fibers 175 (only some of which are illustrated for ease in viewing). The first multiplexing device 160 assigns a set of four wavelengths to each channel fiber 165; and each second multiplexing device 170 assigns a set of eight wavelengths to each output fiber 175. Accordingly, the system 150 also can accommodate up to thirty-two subscriber signals being carried over the input fiber 155.

In the example shown, the first multiplexing device 160 assigns a first set S1, S1′ of wavelengths to a first channel fiber 165, a second set S2, S2′ of wavelengths to a second channel fiber 165, a third set S3, S3′ of wavelengths to a third channel fiber 165, a fourth set S4, S4′ of wavelengths to a fourth channel fiber 165, a fifth set S5, S5′ of wavelengths to a fifth channel fiber 165, a sixth set S6, S6′ of wavelengths to a sixth channel fiber 165, a seventh set S7, S7′ of wavelengths to a seventh channel fiber 165, and an eighth set S8, S8′ of wavelengths to an eighth channel fiber 165. Each of the second multiplexing devices 170 assigns a first set SA, SA′ of wavelengths to a first output fiber 175, a second set SB, SB′ of wavelengths to a second output fiber 175, a third set SC, SC′ of wavelengths to a third output fiber 175, and a fourth set SD, SD′ of wavelengths to a fourth output fiber 175.

For each of the channel fibers 115, 165, each of the output fibers 125, 175 is assigned a wavelength that matches one of the wavelengths assigned to the channel fiber 115, 165. In some implementations, either the wavelength sets SA-SD, SA′-SD′ assigned to the channel fibers 115, 165 or the wavelength sets S1-S8, S1′-S8′ assigned to the output fibers 125, 175 include consecutive wavelengths. The other wavelength sets include alternately assigned wavelengths. Accordingly, in each multiplexing system 100, 150 each output channel 125, 175 carries only one subscriber signal.

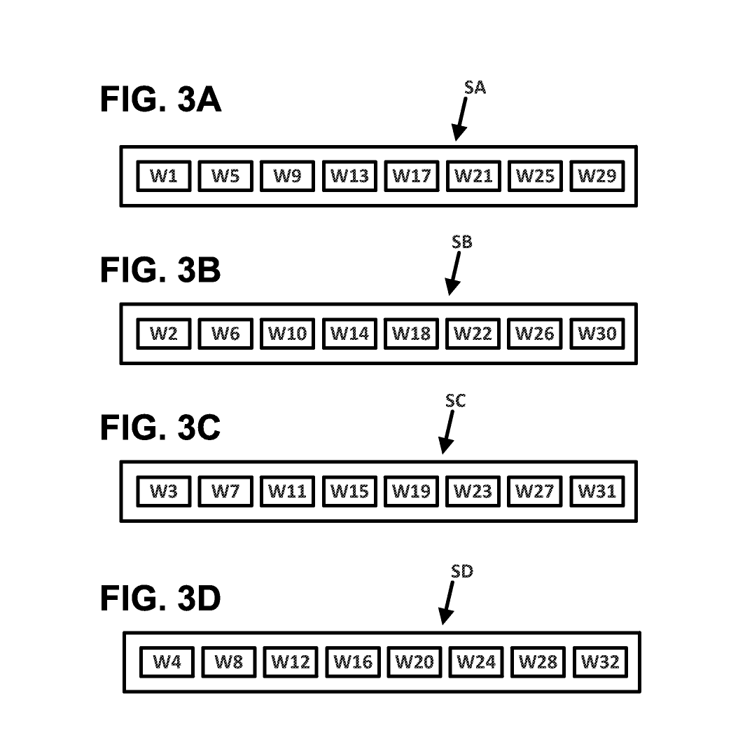

For example, as shown in FIGS. 3A-3D, the four sets SA-SD of eight wavelengths include alternately assigned wavelengths. These wavelength sets SA-SD can be assigned to the channel fibers 115 of the first multiplexing system 100 or to the output fibers 175 of the second multiplexing system 150. A first wavelength W1 is assigned to the first set SA, the next consecutive wavelength W2 is assigned to the next set SB, the next consecutive wavelength W3 is assigned to the next set SC, and the next consecutive wavelength W4 is assigned to the next set SD. The next consecutive wavelength, wavelength W5, is assigned to the first set SA and the pattern continues.

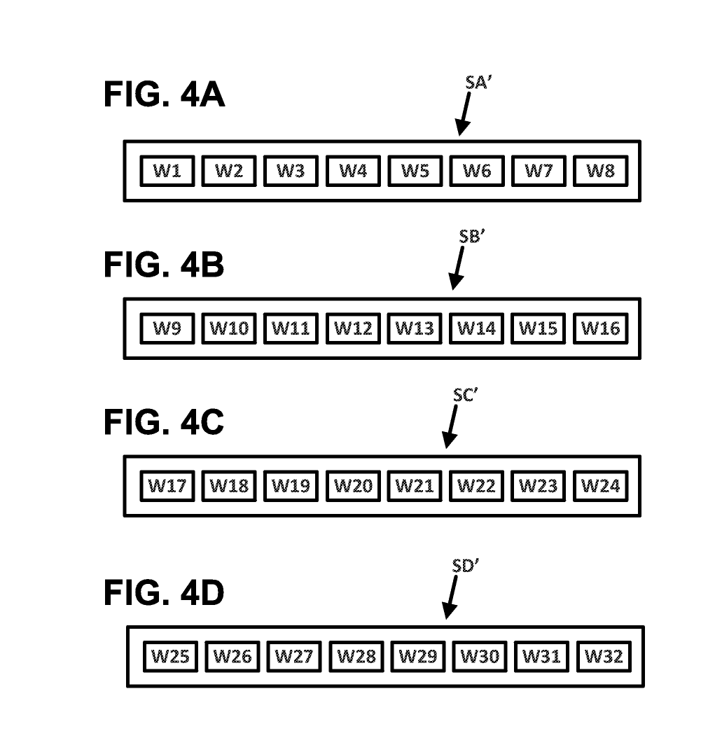

Alternatively, in FIGS. 4A-4D, the four sets SA′-SD′ of eight wavelengths include consecutive assigned wavelengths. These wavelength sets SA′-SD′ can be assigned to the channel fibers 115 of the first multiplexing system 100 or to the output fibers 175 of the second multiplexing system 150. The first eight wavelengths W1-W8 are assigned to the first set SA′, the next eight wavelengths W9-W16 are assigned to the second set SB′, the next eight wavelengths W17-W24 are assigned to the third set SC′, and the next eight wavelengths W25-W32 are assigned to the fourth set SD′. Accordingly, each set SA′-SD′ includes a range of wavelengths that spans multiple subscriber wavelengths.

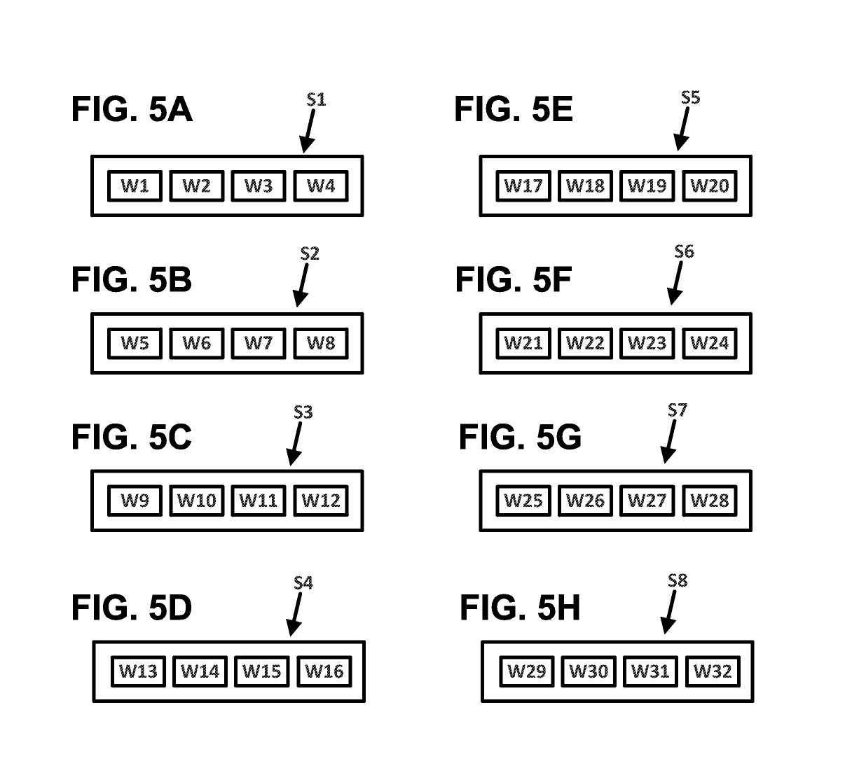

FIGS. 5A-5H illustrate eight example sets S1-S8 of four consecutive wavelengths. These wavelength sets S1-S8 can be assigned to the output fibers 125 of the first multiplexing system 100 or to the channel fibers 165 of the second multiplexing system 150. The first four wavelengths W1-W4 are assigned to the first set S1, the next four wavelengths W5-W8 are assigned to the second set S2, the next four wavelengths W9-W12 are assigned to the third set S3, the next four wavelengths W13-W16 are assigned to the fourth set S4, the next four wavelengths W17-W20 are assigned to the fifth set S5, the next four wavelengths W21-W24 are assigned to the sixth set S6, the next four wavelengths W25-W28 are assigned to the seventh set S7, and the next four wavelengths W29-W32 are assigned to the eight set S8. Accordingly, each set S1-S8 includes a range of wavelengths that spans multiple subscriber wavelengths.

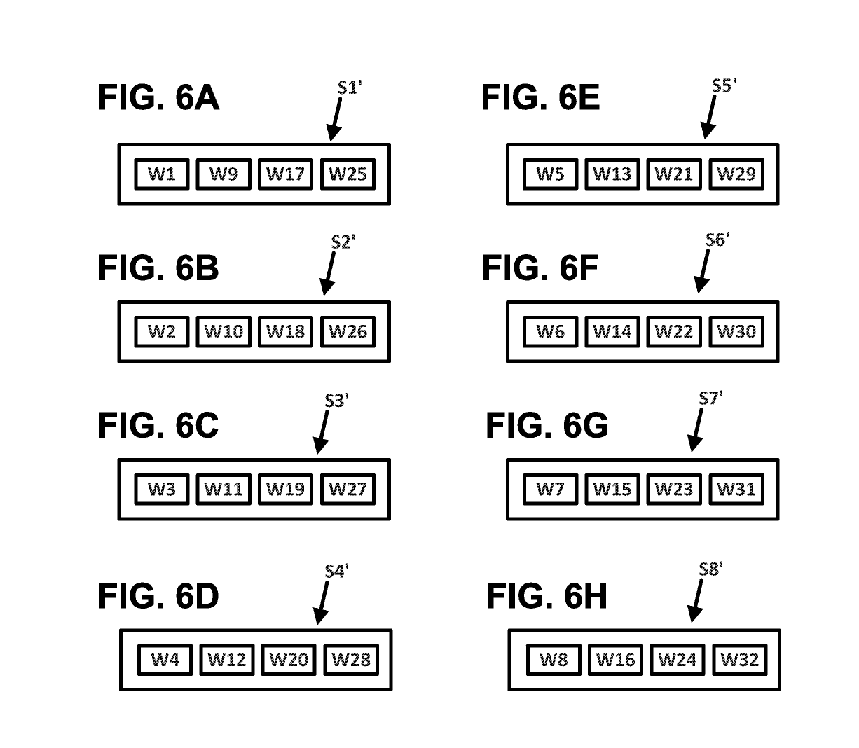

FIGS. 6A-6H illustrate eight example sets S1′-S8′ of four alternately assigned wavelengths. These wavelength sets S1′-S8′ can be assigned to the output fibers 125 of the first multiplexing system 100 or to the channel fibers 165 of the second multiplexing system 150. A first wavelength W1 is assigned to the first set S1′, the next consecutive wavelength W2 is assigned to the second set S2′, the next consecutive wavelength W3 is assigned to the third set S3′, and the next consecutive wavelength W4 is assigned to the fourth set S4′, the next consecutive wavelength W5 is assigned to the fifth set S5′, the next consecutive wavelength W6 is assigned to the sixth set S6′, and the next consecutive wavelength W7 is assigned to the seventh set S7′, and the next consecutive wavelength W8 is assigned to the eighth set S8′. The next consecutive wavelength, wavelength W9, is assigned to the first set S1′ and the pattern continues.

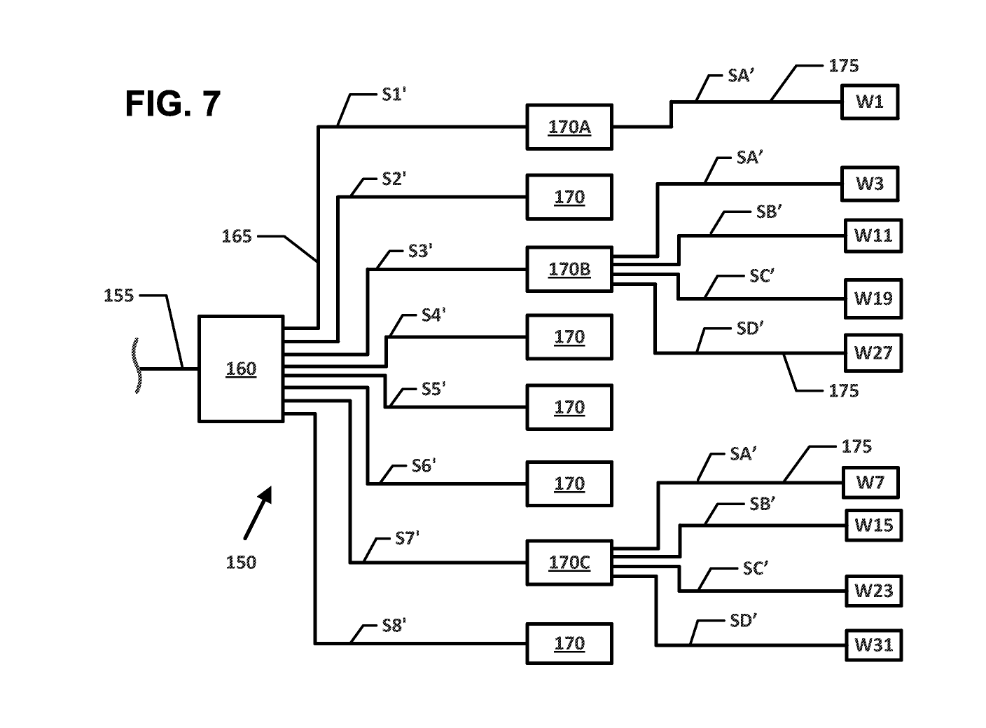

FIG. 7 illustrates the second multiplexing system 150 where alternately assigned wavelengths sets S1′-S8′ are assigned to the channel fibers 165 and consecutive assigned wavelengths sets SA′-SD′ are assigned to the output fibers 175. Each output fiber 175 carries only one of the subscriber signals from the input fiber 155. The wavelengths W1-W32 of some of the subscriber signals are shown associated with their corresponding output fibers 175. Only some wavelengths are shown for ease in viewing.

The first multiplexing device 160 separates out the subscriber signals so that the signals having wavelengths W1, W9, W17, and W25 are output onto the first channel fiber 165. The signals having the other wavelengths are output onto the other channel fibers 165. For example, the subscriber signals having wavelengths W3, W11, W19, and W27 are output onto the third channel fiber 165; and the subscriber signals having wavelengths W7, W15, W23, and W31 are output onto the seventh channel fiber 165

The channel fibers 165 are each input into a second multiplexing device 170. The second multiplexing devices 170 are identically configured, thereby reducing manufacturing and inventory costs. A first one 170A of the second multiplexing devices 170 receives the four subscriber signals from the first channel fiber 165. The second multiplexing device 170A separates the four signals by wavelengths onto four separate output fibers 175. For example, the second multiplexing device 170A directs the subscriber signal having the wavelength W1 onto the first output line 175.

A second one 170B of the second multiplexing devices 170 receives the four subscriber signals from the third channel fiber 165. The second multiplexing device 170B separates the four signals by wavelengths onto four separate output fibers 175. For example, the second multiplexing device 170B directs the subscriber signal having the wavelength W3 onto the first output line 175, the subscriber signal having the wavelength W11 onto the second output line 175, the subscriber signal having the wavelength W19 onto the third output line 175, and the subscriber signal having the wavelength W27 onto the fourth output line 175.

A third one 170C of the second multiplexing devices 170 receives the four subscriber signals from the seventh channel fiber 165. The second multiplexing device 170C separates the four signals by wavelengths onto four separate output fibers 175. For example, the second multiplexing device 170C directs the subscriber signal having the wavelength W7 onto the first output line 175, the subscriber signal having the wavelength W15 onto the second output line 175, the subscriber signal having the wavelength W23 onto the third output line 175, and the subscriber signal having the wavelength W31 onto the fourth output line 175.

Of course, other distributed wave division multiplexing systems can include first and second multiplexing devices with different numbers of channel and output lines. The product of the number of channel lines and the number of output lines in the system provides the number of subscriber signals that can be accommodated by the system.

A method of configuring a distributed wave division multiplexing system 100, 150 includes configuring a first multiplexing device 110, 160 to associate a respective set of wavelengths with each of X number of channel fibers 115, 165, each set including Y number of wavelengths; and configuring a second multiplexing device 120, 170 to associate each of Y number of output lines 125, 175 with a respective set of wavelengths, each set including X number of wavelengths. The first and second WDMs 110, 120, 160, 170 are further configured so that each of the Y number of wavelengths of the set associated with a first of the channel fibers 115, 165 is associated with a different one of the output fibers 125, 175. The first and second multiplexing devices 110, 120, 160, 170 are further configured so that each of the X number of wavelengths of the set associated with a first of the output fibers 125, 175 is associated with a different one of the channel fibers 115, 165.

In certain implementations, the method includes determining a number of unique wavelengths over which optical subscriber signals are transmitted. The product of the value of X and the value of Y (i.e., X*Y) is greater than or equal to the determined number of unique wavelengths.

In certain implementations, the method includes coupling the second WDM 120, 170 to the first multiplexing device 110, 160 so that the second multiplexing device 120, 170 receives one of the channel fibers 115, 165 as input.

In certain implementations, the method includes configuring a plurality of additional multiplexing devices 120, 170 identically to the second multiplexing device 120, 170; and coupling the additional multiplexing devices 120, 170 to the first multiplexing device 110, 160 so that each channel fiber 115,165 is input into one of the additional multiplexing devices 120, 170.

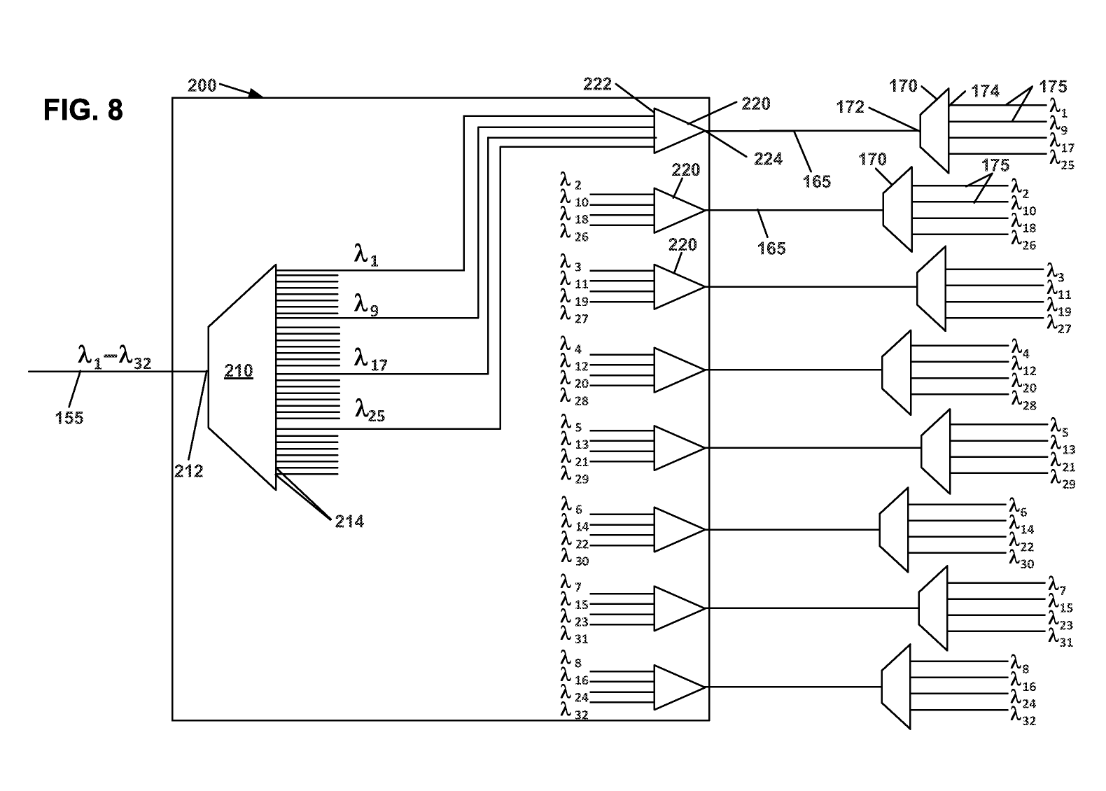

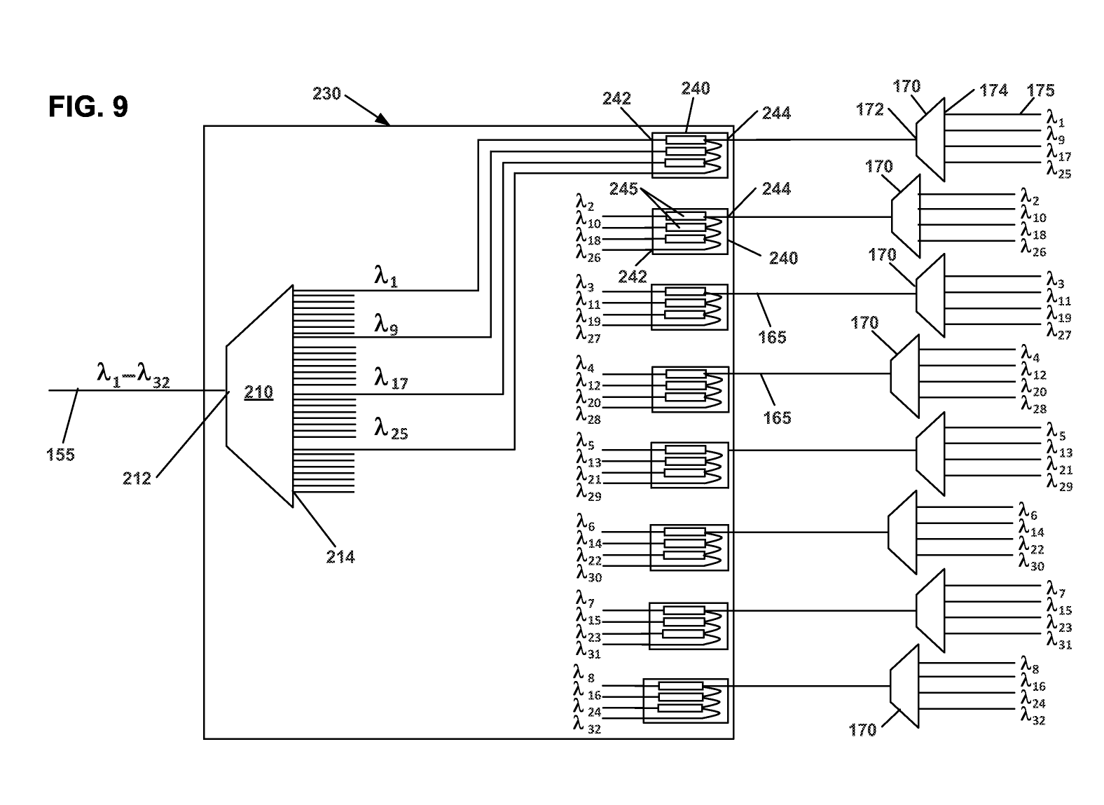

FIGS. 8 and 9 are schematic diagrams of the distributed wave division multiplexing system 150 of FIG. 2 showing example implementations 200, 230 of the first multiplexing device 160. The implementations 200, 230 shown separate optical signals from one fiber 155 onto thirty-two different fibers 175. In other examples, however, the implementations 200, 230 can separate the optical signals onto any desired number of optical fibers 175 based on the number of distinct optical wavelengths or wavelength bands.

The first multiplexing device implementation 200, 230 includes a WDM 210 having an input 212 and multiple outputs 214. In certain examples, the WDM 210 has between two and sixty-four outputs 214. In certain examples, the WDM 210 has between four and sixteen outputs 214. In certain examples, the WDM 210 has between sixteen and sixty-four outputs. In an example, the WDM 210 has sixteen outputs 214. In an example, the WDM 210 has thirty-two outputs 214. In an example, the WDM 210 has sixty-four outputs 214. In still other implementations, the WDM 210 can have a greater number of outputs 214.

The input 212 of the WDM 210 receives optical signals from the input fiber 155 routed to the first multiplexing device 200. In an example, the input 212 of the WDM 210 receives the input fiber 155. The WDM 210 separates the optical signals by wavelength onto the outputs 214. In the example shown, each output 214 of the WDM 210 is associated with only one respective wavelength. In other examples, each output 214 can be associated with two respective wavelengths. In still other examples, each output 214 can be associated with one wavelength in common with the other outputs 214 and one wavelength unique from the other outputs 214. Only optical signals of the associated wavelength(s) enter and/or exit the WDM 210 at that respective output 214. In some implementations, the outputs 214 of the WDM are the outputs of the first multiplexing device 160.

In other implementations, the first multiplexing device implementations 200, 230 also include multiple combining devices 220, 240. Each combining device 220, 240 has multiple inputs 222, 242 and one or more outputs 224, 244. In examples, the outputs 224, 244 form the outputs of the first multiplexing device. The inputs 222, 242 of each combining device 220, 240 receive optical signals from select outputs 214 of the WDM 210. For example, each input 222, 242 of each combining device 220, 240 is configured to receive one of the outputs 214 of the WDM 210. Each of the combining devices 220, 240 receive a different combination of outputs 214 from the WDM 210. For example, each output 214 of the WDM is directed to a different combining device input 222, 242. In some implementations, the inputs 222, 242 of each combining device 220, 240 receive optical signals from consecutive outputs 214 of the WDM 210. In other implementations, the inputs 222, 242 of each combining device 220, 240 receive optical signals from non-consecutive outputs 214 of the WDM 210 (e.g., see FIG. 8).

Each combining device 220, 240 is configured to combine the optical signals received from the WDM 210 onto one or more of the channel fibers 165 at one or more outputs 224, 244. In an example, each combining device 220, 240 is configured to combine all of the optical signals that were received from the WDM 210 at the inputs 222, 242 onto a channel fiber 165 at a single output 224, 244. In other examples, the combining device 220, 240 can combine the optical signals from some of the WDM outputs 214 onto a first channel fiber 165 and the optical signals from others of the WDM outputs 214 onto a second channel fiber 165. As discussed above, the channel fibers 165 are routed to the second multiplexing devices 170.

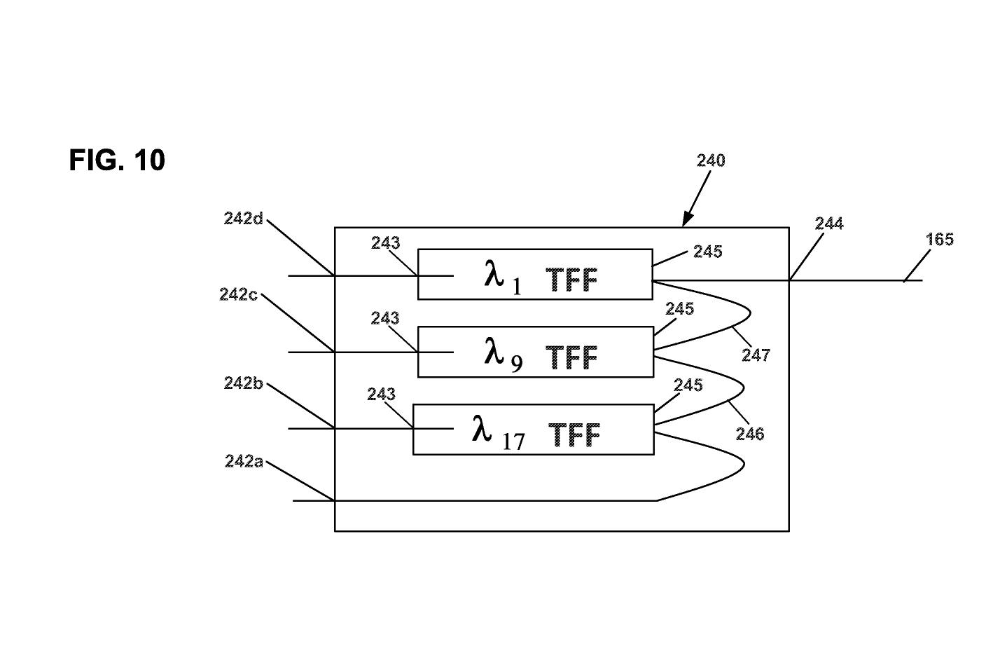

In the example shown in FIG. 8, the combining devices are implemented by optical power splitters 220. In the example shown in FIG. 9, the combining devices are implemented by band splitters 240, which will be discussed in more detail herein with respect to FIG. 10.

Each second multiplexing device 170 has an input 172 and multiple outputs 174. Each input 172 receives optical signals from one of the channel fibers 165. The second multiplexing device 170 separates out the optical signals carried by the channel fiber 165 into different wavelengths. The optical signals of each separated wavelength are output onto a different output fiber 175. In certain examples, each output 174 of the second multiplexing device 170 is associated with a particular wavelength range or set. Each of the outputs 174 of the same second multiplexing device 170 is associated with a different wavelength range or set than the other outputs 174. Each of the second multiplexing devices 170 has an output associated with any and all wavelengths output by the WDM 210. In examples, all of the second multiplexing devices 170 coupled to the first multiplexing device 160 can be identical to each other. In examples, any of the second multiplexing devices 170 coupled to the first multiplexing device 160 are interchangeable with each other.

Of course, the above teachings can be used to implement the first multiplexing device 110 of FIG. 1. In such an embodiment, the WDM outputs 214 would be routed to four combining devices instead of eight combining devices 220, 240. Each combining device would have eight inputs instead of four inputs 222, 242. In other implementations, the first multiplexing device of a distributed wave division multiplexing system may include any desired number of combining devices having any desired number of inputs to accommodate any desired number of WDM outputs. In still other implementations, the first multiplexing device could include any desired number of WDM's having any desired number of outputs.

FIG. 10 illustrates one example combining device 240 suitable for use as one of the combining devices 240 of FIG. 9. The combining device 240 has multiple inputs 242 and at least one output 244. In an example, the combining device 240 has only one output 244. Each input 242 receives optical signals from one of the WDM outputs 214. The combining device 240 includes filter structure that combines the optical signals received at the inputs 242 onto a channel fiber 165 that extends from the output 244. In certain examples, the filter structure includes one or more Thin Film Filters (TFFs) 245. Each TFF 245 has two inputs and one output. Each TFF 245 is configured to receive optical signals from one of the inputs 242 of the combining device 240.

In the example shown, the combining device 240 includes three 3-channel TFFs 245. A first of the TFFs 245 receives optical signals from a first input 242a and from a second input 242b. The first TFF 245 combines the optical signals from the first and second inputs 242a, 242b and outputs the combined signals onto an intermediate fiber 246. A second of the TFFs 245 receives optical signals from the intermediate fiber 246 and from a third input 242c. The second TFF 245 combines the optical signals from intermediate fiber 246 and from the third input 242c and outputs the combined signals onto another intermediate fiber 247. A third of the TFFs 245 receives optical signals from the intermediate fiber 247 and from a fourth input 242d. The third TFF 245 combines the optical signals from intermediate fiber 247 and from the fourth input 242d and outputs the combined signals onto the channel fiber 165 at the output 244.

In some implementations, each TFF 245 is configured to separate out optical signals having a particular wavelength or band from a remainder of the optical signals. For example, the third TFF 245 would filter any optical signals received from the channel fiber 165 so that optical signals of a particular wavelength (e.g., λ₁) would be output to the fourth input 242d and a remainder of the optical signals would be output to the intermediate fiber 247. Likewise, the second TFF 245 would filter any optical signals received from the intermediate fiber 247 so that optical signals of a particular wavelength (e.g., λ₉) would be output to the third input 242c and a remainder of the optical signals would be output to the intermediate fiber 246. The first TFF 245 would filter any optical signals received from the intermediate fiber 246 so that optical signals of a particular wavelength (e.g., λ₁₇) would be output to the second input 242b and a remainder of the optical signals would be output to the first input 242a.

Of course, in other implementations, each combining device 240 can have any desired number of inputs 242 and/or outputs 244 and, accordingly, any desired number of TFFs 245. Also, in other implementations, the TFFs 245 of the multiplexing devices 24 can have any desired wavelengths or wavelength bands. In still other implementations, the combining device 240 can have different filter structure other than TFFs.

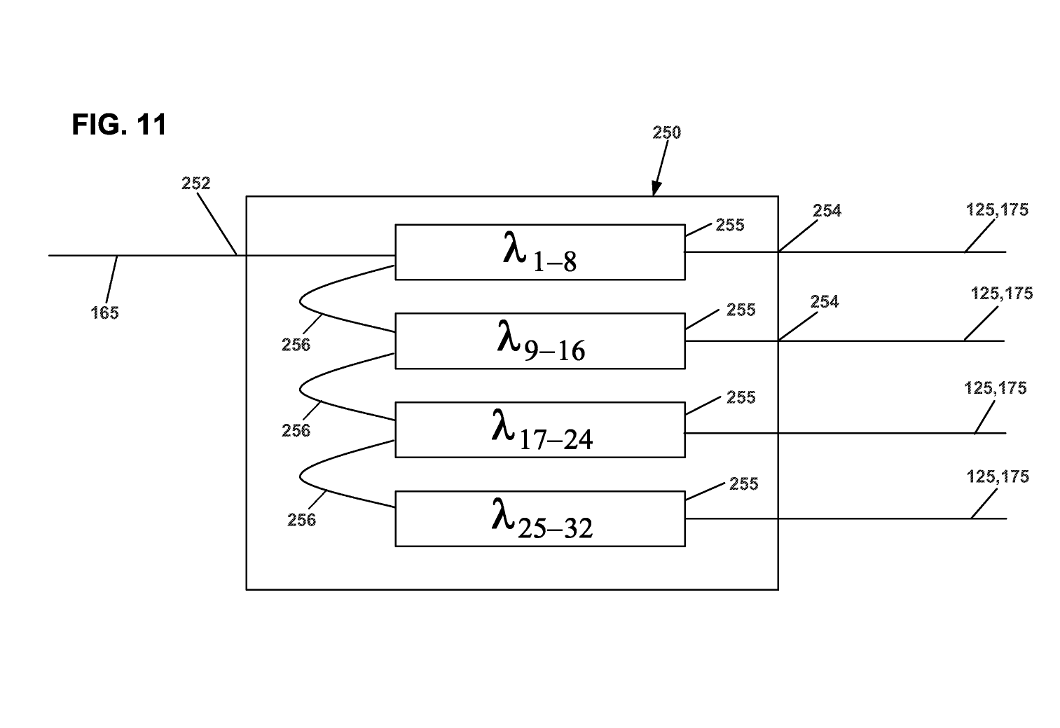

FIG. 11 illustrates one example multiplexing device 250 suitable for use as one of the second multiplexing devices 120, 170 of FIG. 1 2, 8, or 9. The multiplexing device 250 has an input 252 and multiple outputs 254. The input 252 receives one of the channel fibers 165 from the first multiplexing device 160. The multiplexing device 250 includes filter structure that separates out optical signals carried by the channel fiber 165 onto multiple output fibers 125, 175 that extend from outputs 254 of the multiplexing device 250. Each output fiber 125, 175 is associated with a particular wavelength range or set. In certain examples, the wavelength ranges or sets for each output 254 are defined so that only one wavelength of the range or set for each output 254 is received from the channel fiber 165.

In certain examples, the filter structure includes one or more Thin Film Filters (TFFs) 255. Each TFF 255 is associated with a particular output fiber 125, 175 onto which the TFF 255 is configured to pass optical fibers having a particular range of wavelengths. Each TFF 255 within the multiplexing device 250 is configured for a different range of wavelengths. In examples, the TFF 255 within the multiplexing device 250 have non-overlapping wavelength ranges. In the example shown, a first TFF 255 has a range of wavelengths λ₁-λ₈, a second TFF 255 has a range of wavelengths λ₉-λ₁₆, a third TFF 255 has a range of wavelengths λ₁₇-λ₂₄, and a fourth TFF 255 has a range of wavelengths λ₂₅-λ₃₂. In other examples, a greater or lesser number of the TFFs 255 can be associated with greater or lesser ranges of wavelengths.

In the example shown, the multiplexing device 250 includes four 3-channel TFFs 255. A first of the TFFs 255 receives optical signals from the channel fiber 165 via the input 252. In the example shown, the first TFF 255 outputs any received optical signals that have wavelengths in the range of λ₁-λ₈ onto the first output 254. Since the first TFF 255 of the first multiplexing device 250 receives the wavelengths λ₁, λ₉, λ₁₇ λ₂₅ from a first channel fiber 165, the first TFF 255 will output optical signals having the wavelength λ₁ onto a first output fiber 125, 175. Any remaining optical signals are output onto an intermediate channel 256.

A second of the TFFs 255 receives any optical signals from the intermediate channel 256 output from the first TFF 255. The second TFF 255 outputs any received optical signals that have wavelengths in the range of λ₉-λ₁₆ onto a second output 254. Since the second TFF 255 of the first multiplexing device 250 receives the wavelengths λ₁, λ₉, λ₁₇ λ₂₅ from a first channel fiber 165, the second TFF 255 will output optical signals having the wavelength λ₉ onto a second output fiber 125, 175. Any remaining optical signals are output onto an intermediate channel 256.

A third of the TFFs 255 receives any optical signals from the intermediate channel 256 output from the second TFF 255. The third TFF 255 outputs any received optical signals that have wavelengths in the range of λ₇-λ₂₅ onto a third output 254. Since the third TFF 255 of the first multiplexing device 250 receives the wavelengths λ₁, λ₉, λ₁₇ λ₂₅ from a first channel fiber 165, the third TFF 255 will output optical signals having the wavelength λ₁₇ onto a third output fiber 125, 175. Any remaining optical signals are output onto an intermediate channel 256.

A fourth of the TFFs 255 receives any optical signals from the intermediate channel 256 output from the third TFF 255. The fourth TFF 255 outputs any received optical signals that have wavelengths in the range of λ₂₆-λ₃₂ onto a fourth output 254. Since the fourth TFF 255 of the first multiplexing device 250 receives the wavelengths λ₁, λ₉, λ₁₇ λ₂₅ from a first channel fiber 165, the fourth TFF 255 will output optical signals having the wavelength λ₂₅ onto a fourth output fiber 125, 175.

Of course, in other implementations, each multiplexing device 250 can have any desired number of inputs 252 and/or outputs 254 and, accordingly, any desired number of TFFs 255. Also, in other implementations, the TFFs 255 of the multiplexing devices 250 can have any desired wavelength ranges. In still other implementations, the multiplexing devices 250 can have different filter structure other than TFFs.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A distributed wavelength division multiplexer architecture comprising:
a first multiplexing device including a first wave division multiplexer, the first multiplexing device having an input and a plurality of first outputs, the first multiplexing device having a first filter criteria that assigns a respective set of subscriber wavelengths to each first output, each set of subscriber wavelengths being different from each other set of subscriber wavelengths; and
second wavelength division multiplexers having second inputs coupled to the first outputs of the first multiplexing device, the second wavelength division multiplexers each including a plurality of second outputs and a second filter criteria that assigns a subscriber wavelength from each different set of subscriber wavelengths to each of the second outputs.

2. The distributed wavelength division multiplexer architecture of claim 1, wherein the second wavelength division multiplexers are identical to each other.

3. The distributed wavelength division multiplexer architecture of claim 1, wherein the different sets of subscriber wavelengths corresponding to the first multiplexing device are not assigned duplicate subscriber wavelengths, and wherein the second outputs corresponding to the second wavelength division multiplexers are not assigned duplicate subscriber wavelengths.

4. The distributed wavelength division multiplexer architecture of claim 1, wherein the plurality of first outputs include eight first outputs and each set of subscriber wavelengths includes four subscriber wavelengths.

5. The distributed wavelength division multiplexer architecture of claim 1, wherein the plurality of first outputs include four first outputs and each set of subscriber wavelengths includes eight subscriber wavelengths.

6. The distributed wavelength division multiplexer architecture of claim 1, wherein the first outputs are outputs of the first wave division multiplexer.

7. The distributed wavelength division multiplexer architecture of claim 1, wherein outputs of the first wave divisional multiplexer are routed to multiple combining devices, wherein the first filter criteria determines which outputs of the first wave division multiplexer are sent to each of the combining devices, and wherein the first outputs are outputs of the combining devices.

8. The distributed wave division multiplexing system of claim 7, wherein the combiner devices include optical power splitters.

9. The distributed wave division multiplexing system of claim 7, wherein the combiner devices include band splitters.

10. The distributed wave division multiplexing system of claim 1, wherein each set of subscriber wavelengths includes consecutive wavelengths.

11. The distributed wave division multiplexing system of claim 1, wherein each set of subscriber wavelengths includes non-consecutive wavelengths.

12. A distributed wave division multiplexing system comprising:
an input fiber carrying a plurality of subscriber signals each having a unique wavelength;
a plurality of channel fibers;
a first multiplexing device including a first WDM configured to receive the input fiber, the first multiplexing device being configured to separate the subscriber signals carried by the input fiber onto the channel fibers, the first multiplexing device having a first set of filter criteria that assigns a corresponding plurality of wavelengths to each of the channel fibers so that the wavelength of each subscriber signal is assigned to one of the channel fibers, the first multiplexing device separating the subscriber signals so that each channel fiber will receive any subscriber signal having one of the corresponding wavelengths;
a plurality of output fibers;
a second multiplexing device coupled to the first multiplexing device to receive one of the channel fibers, the second multiplexing device being configured to separate the subscriber signals carried by the received channel fiber onto the output fibers, the second multiplexing device having a second set of filter criteria that assigns a corresponding plurality of wavelengths to each of the output fibers so that the wavelength of each subscriber signal carried by the received channel fiber is assigned to one of the output fibers, the second multiplexing device separating the subscriber signals carried by the received channel fiber so that each output fiber will receive any subscriber signal having one of the corresponding wavelengths of that output fiber;
wherein, for each of the channel fibers, each of the output fibers has a corresponding wavelength that matches one of the corresponding wavelengths of the channel fiber.

13. The distributed wave division multiplexing system of claim 12, further comprising:
a plurality of additional multiplexing devices coupled to the first multiplexing device, each of the additional WDMs being identically configured with the second multiplexing device, wherein each of the channel fibers is input into one of the additional multiplexing devices.

14. The distributed wave division multiplexing system of claim 12, wherein the first multiplexing device separates the subscriber signals onto four channel fibers and wherein the second multiplexing device separates the subscriber signals onto eight output fibers.

15. The distributed wave division multiplexing system of claim 12, wherein the first multiplexing device separates the subscriber signals onto eight channel fibers and wherein the second multiplexing device separates the subscriber signals onto four output fibers.

16. The distributed wave division multiplexing system of claim 12, wherein the corresponding plurality of wavelengths assigned by the first set of filter criteria includes consecutive wavelengths.

17. The distributed wave division multiplexing system of claim 12, wherein the corresponding plurality of wavelengths assigned by the first set of filter criteria includes non-consecutive wavelengths.

18. The distributed wave division multiplexing system of claim 12, wherein the first multiplexing device includes a DWDM.

19. The distributed wave division multiplexing system of claim 12, wherein the first multiplexing device includes a CWDM.

20. The distributed wave division multiplexing system of claim 12, wherein the second multiplexing device includes a DWDM.

21. The distributed wave division multiplexing system of claim 12, wherein the second multiplexing device includes a CWDM.

22. A method of configuring a distributed wave division multiplexing system, the method comprising:
determining a number of unique wavelengths over which optical subscriber signals are transmitted;
configuring a first multiplexing device to associate a respective set of wavelengths with each of X number of channel fibers, each set including Y number of wavelengths; and
configuring a second multiplexing device to associate each of Y number of output lines with a respective set of wavelengths, each set including X number of wavelengths, wherein each of the Y number of wavelengths of the set associated with a first of the channel fibers is associated with a different one of the output fibers, and wherein each of the X number of wavelengths of the set associated with a first of the output fibers is associated with a different one of the channel fibers, wherein X*Y is greater than or equal to the determined number of unique wavelengths.

23. The method of claim 22, further comprising coupling the second multiplexing device to the first multiplexing device so that the second multiplexing device receives one of the channel fibers as input.

24. The method of claim 23, further comprising:
configuring a plurality of additional wave division multiplexers identically to the second wave division multiplexer; and
coupling the additional wave division multiplexers to the first wave division multiplexer so that each channel fiber is input into one of the additional wave division multiplexers.

25. The method of claim 22, wherein X=4.

26. The method of claim 22, wherein X=8.

27. The method of claim 22, wherein Y=4.

28. The method of claim 22, wherein Y=8.

29. The distributed wave division multiplexing system of claim 22, wherein the first multiplexing device includes a DWDM.

30. The distributed wave division multiplexing system of claim 22, wherein the first multiplexing device includes a CWDM.

31. The distributed wave division multiplexing system of claim 22, wherein the second multiplexing device is a DWDM.

32. The distributed wave division multiplexing system of claim 22, wherein the second multiplexing device is a CWDM.
